(19) United States
(12) Patent Application Publication
(10) Pub. No.: US 2002/0192531 A1
(43) Pub. Date: Dec. 19, 2002

(54) Liquid reactant flow field plates for liquid feed fuel cells

(76) Inventors: Joerg Zimmerman, Vancouver (CA); Kevin M. Colbow, North Vancouver (CA); Olen R. Vanderleeden, Coquitlam (CA); Peter D. Gibb, Coquitlam (CA)

Correspondence Address: Robert W. Fieseler, McAndrews, Held & Malloy, Ltd., 34th Floor, 500 West Madison Street, Chicago, IL, 60661, US

(21) Appl. No.: 10/189,119

(22) Filed: Jul. 2, 2002

Related U.S. Application Data
(63) Continuation of application No. 09/606,603, filed on Jun. 29, 2000.
Application No. 09/606,603 is a continuation-in-part of application No. 09/223,356, filed on Dec. 30, 1998, now abandoned.

(51) Int. Cl. H01M 8/02; H01M 8/10

(52) U.S. Cl. 429/38; 429/30

(57) ABSTRACT

A flow field plate for a liquid feed fuel cell has a liquid reactant (for example, fuel) flow field comprising a plurality of horizontal parallel substantially straight channels formed on one major surface of the plate. The plate has another reactant (for example, oxidant) flow field on the other major surface of the plate. The liquid reactant channels may have an open width less than about 0.75 millimeter and/or a length to cross sectional area ratio between about 2180:1 to about 6200:1. A simple four-port configuration is employed for the inlets and outlets for the reactants. The liquid reactant can also serve as a coolant for the fuel cell.

### CROSS-REFERENCE TO RELATED APPLICATION(S)

This application is a continuation-in-part of U.S. patent application Ser. No. 09/223,356 filed Dec. 30, 1998, entitled “Fuel Cell Fluid Flow Field Plate and Methods of Making Fuel Cell Flow Field Plates”. The '356 application is incorporated herein by reference in its entirety.

### FIELD OF THE INVENTION

The present invention relates to a liquid reactant flow field plate for a liquid feed fuel cell. More particularly, the invention relates to liquid reactant flow field plates, each comprising a plurality of substantially straight parallel elongated channels for directing a liquid reactant within a fuel cell and to configurations of reactant ports in the flow field plates.

### BACKGROUND OF THE INVENTION

Electrochemical fuel cells convert reactants, namely fuel and oxidants, to generate electric power and reaction products. Electrochemical fuel cells generally employ an electrolyte disposed between two electrodes, namely a cathode and an anode. The electrodes each comprise an electrocatalyst disposed at the interface between the electrolyte and the electrodes to induce the desired electrochemical reactions. The fuel fluid stream which is supplied to the anode may be a gas such as, for example, substantially pure hydrogen or a reformate stream comprising hydrogen. Alternatively, a liquid fuel stream such as, for example, aqueous mixtures of methanol, dimethyl ether, or the like may be used. A fuel cell supplied with a liquid reactant is known as a liquid feed fuel cell. The oxidant fluid stream, which is supplied to the cathode, typically comprises oxygen, such as substantially pure oxygen, or a dilute oxygen stream such as air.

Solid polymer fuel cells employ a solid polymer electrolyte, or ion exchange membrane. The membrane is typically interposed between two electrode layers, forming a membrane electrode assembly (“MEA”). While the membrane is typically proton conductive, it also acts as a barrier, isolating the fuel and oxidant streams from each other on opposite sides of the MEA. The MEA is typically disposed between two plates to form a fuel cell assembly. The plates typically act as current collectors and provide support for the adjacent electrodes. The fuel cell assembly is typically compressed to ensure good electrical contact between the plates and the electrodes, in addition to good sealing between fuel cell components. A plurality of fuel cell assemblies may be combined in series or in parallel to form a fuel cell stack. In a fuel cell stack, a plate may be shared between two adjacent fuel cell assemblies, in which case the plate also serves as a separator to fluidly isolate the fluid streams of the two adjacent fuel cell assemblies.

Fuel cell plates, also known as fluid flow field plates, have open channels formed in one or both opposing major surfaces for directing reactants and/or coolant fluids to specific portions of such major surfaces. The open channels also provide passages for the removal of reaction products, depleted reactant streams, and/or heated coolant streams. For an illustration of a fluid flow field plate, see, for example, U.S. Pat. No. 4,988,583. Where the major surface of a fluid flow field plate faces an MEA, the open channels typically direct a reactant across substantially all of the electrochemically active area of the adjacent MEA. Where the major surface of a fluid flow field plate faces another flow field plate, the channels formed by their cooperating surfaces may be used for carrying a coolant for controlling the temperature of the fuel cell assemblies.

In the aforementioned '356 application, it was disclosed that unconventional elongated flow field plates with a plurality of substantially straight channels may be used, for instance, to obtain satisfactory performance at high current densities in solid polymer electrolyte fuel cell embodiments. Certain disadvantages of serpentine channels may be overcome with the use of substantially straight channels. However, in order to obtain a desired pressure differential between channel inlets and outlets (for example, for purposes of water management), channel dimensions were employed that had not been practical to achieve using conventional milling methods. These dimensions included open widths less than 0.75 millimeters and length to cross-sectional area ratios of between about 2180:1 to about 6200:1. Methods of making flow field plates with such unconventional channel dimensions were also disclosed. Some such methods included embossing a suitable compressible, electrically conductive sheet material (such as expanded graphite), and injection or compression molding a suitable electrically conductive material (such as a composite of graphite and a thermoplastic resin).

The desirable construction of a flow field plate for a liquid reactant may be somewhat different than that for a gaseous reactant. The preferred channel dimensions for fluid distribution may be influenced by differences in fluid properties. The use of a liquid instead of a gas may also affect other cell processes including water management and cell cooling. For instance, direct methanol fuel cells (DMFCs) typically use an aqueous methanol mixture as a liquid fuel and use air as a gaseous oxidant. Water management at the fuel side is different because liquid water is generally always present over the entire anode. The liquid fuel reactant stream may be circulated and thus can serve to cool the fuel cell, thereby obviating the need for additional cooling fluids and associated flow fields. In DMFCs, fuel flow plates comprising substantially straight vertical fuel channels have been employed. Gaseous oxidant may be admitted at an upper channel end and exhausted at a lower channel end such that gravity assists in removal of product water. Liquid fuel may be admitted at a lower channel end and exhausted at an upper channel end such that gaseous reaction products escape more readily.

### SUMMARY OF THE INVENTION

Unconventional liquid reactant flow field plates with substantially straight narrow and/or elongated channels may be used to obtain satisfactory performance at high current densities in liquid feed fuel cells. Such cells comprise a liquid reactant flow field plate with opposing first and second major surfaces and at least one substantially straight narrow and/or elongated liquid channel formed in the first major surface extending substantially between two opposing edges of the liquid reactant flow field plate. Preferably, the liquid reactant flow field plate comprises a plurality of substantially straight parallel liquid channels separated by lands.

The liquid reactant flow field plate may be characterized by a narrow liquid channel having an open width of less than 0.75 millimeter. The liquid reactant flow field plate may also be characterized by an elongated liquid channel having a length to cross-sectional area ratio of between about 2180:1 to about 6200:1. During operation of the fuel cell assembly, the flow field plates may be oriented such that the major surfaces are vertical and the liquid channels horizontal. A suitable material for making such plates is expanded graphite. Additional details on the construction of such plates are disclosed in the '356 application, which has been incorporated by reference herein.

At least one channel, and preferably a plurality of channels, may be formed in the second major surface of the flow field plate, thereby creating a second flow field in the plate. Such channels may be oriented parallel to the liquid channels on the first major surface of the plate. The flow field created by these channels may serve to deliver either gaseous or liquid reactants. Thus, an advantage of the present flow field plate is that it is possible to construct an elongated bipolar flow field plate that provides for satisfactory operation at high current density using both liquid and/or gaseous reactants.

For fuel cells employing a liquid fuel reactant, a liquid fuel flow field plate is preferably oriented during fuel cell operation such that the major surfaces are substantially vertical and the liquid fuel channel, or preferably plurality of liquid fuel channels, is substantially horizontal. Further, the liquid fuel flow field plate may comprise a fuel inlet port at one end of the liquid fuel channels, the fuel inlet port being in a lower portion of the flow field plate, and a fuel outlet port at the other end of the-liquid fuel channels, the fuel outlet port being in an upper portion of the flow field plate. This configuration of fuel ports can facilitate carbon dioxide removal. In a bipolar plate-embodiment, channels for oxidant are formed on the second major surface of the flow field plate. Then, the bipolar plate may additionally comprise an oxidant inlet port at one end of the oxidant channels, the oxidant inlet port in an upper portion of the flow field plate, and an oxidant outlet port at the other end of the oxidant channels, the oxidant outlet port in a lower portion of the flow field plate. This configuration of oxidant ports can facilitate liquid water removal. Alternatively, the fuel and oxidant inlet and outlet ports may be arranged symmetrically at each end of the fuel and oxidant channels.

The liquid reactant flow field plates are suitable for use in liquid feed solid polymer electrolyte fuel cells and particularly in direct methanol fuel cells.

### BRIEF DESCRIPTION OF THE DRAWINGS

FIG. 1a is a plan view of a fuel flow field plate for a gaseous feed solid polymer fuel cell.

FIG. 1b is a plan view of a liquid reactant flow field plate for a direct methanol fuel cell.

FIGS. 2a, 2b, and 2c show various port configurations and channel designs for a liquid reactant flow field plate for a direct methanol fuel cell.

FIG. 3 shows the fuel cell voltage versus current density plot for the fuel cells in the Example below.

### DETAILED DESCRIPTION OF PREFERRED EMBODIMENT(S)

A solid polymer electrolyte fuel cell stack comprises fuel cell assemblies stacked in series. Each fuel cell assembly comprises a membrane electrode assembly (MEA) disposed between fuel and oxidant flow field plates. The fuel and oxidant flow field plates respectively distribute fuel and oxidant reactants over the surfaces of the anode and cathode electrodes in the MEAs. The fuel and oxidant flow field plates also provide support and electrical contact to the anodes and cathodes respectively.

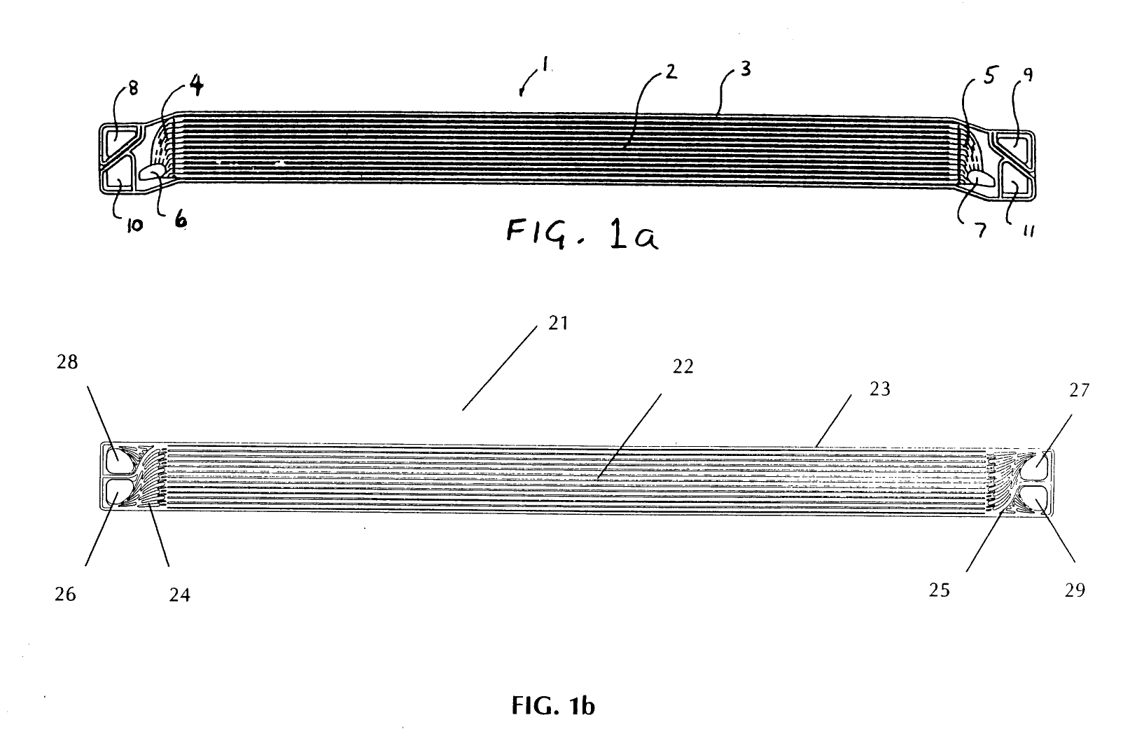

FIG. 1a shows a plan view of a representative elongated flow field plate from the aforementioned '356 application. Here, the elongated plate is a fuel flow field plate that is intended for use in a solid polymer electrolyte fuel cell stack operating on gaseous hydrogen fuel. Fuel flow field plate 1 has two parallel major surfaces, one surface comprising a fuel flow field and the other surface comprising a coolant flow field. The surface shown in FIG. 1a faces and contacts the anode side of an MEA and comprises a plurality of parallel substantially straight fuel channels 2 for distributing fuel over the anode surface. The other surface (not shown) of plate 1 comprises a plurality of parallel substantially straight coolant channels.

A complete fuel cell assembly may be prepared using the fuel flow field plate in FIG. 1a, an MEA, and an oxidant flow field plate in contact with the cathode side of the MEA. The oxidant flow field plate is similar in size and shape to the fuel flow field plate and also comprises a plurality of parallel substantially straight channels for distributing oxidant over the surface of the cathode. A series of such fuel cell assemblies can then be stacked to make a fuel cell stack. In this way, the fuel flow field plate in one fuel cell assembly contacts the oxidant flow field plate in an adjacent fuel cell assembly and thus coolant may be directed between adjacent oxidant and fuel flow field plates.

In FIG. 1a, fuel channels 2 extend substantially between two opposing edges of elongated fuel flow field plate 1. Fuel is admitted at fuel inlet port 6, travels through passages 4, fuel channels 2, passages 5, and exhausts at fuel outlet port 7. The fuel channel area corresponds to the area of the MEA. The passages are not considered part of the channels, and the passages may be curved in reflection of the configuration of the ports. Fuel channels 2 preferably have an open width of less than 0.75 millimeters and a length to cross sectional area ratio between about 2180:1 and 6200:1.

Fuel flow field plate 1 also has coolant inlet port 8 and coolant outlet port 9 which connect to a coolant flow field (not shown) on the opposite side of plate 1. Further, plate 1 comprises oxidant inlet port 10 and oxidant outlet port 11. The various fuel, coolant, and oxidant ports 6, 7, 8, 9, 10, 11 align with similar ports in the other fuel and oxidant flow field plates in the fuel cell stack and collectively form fluid manifolds for supplying and exhausting respective fuel, coolant, and oxidant fluid streams to each fuel cell assembly. Perimeter seal 3 circumscribes the fuel channel area and the various ports to effect appropriate fluid seals.

During the operation of a fuel cell stack, the fuel cell assemblies disclosed herein and hence the flow field plates are oriented such that the major surfaces are substantially vertical and such that the channels in the fuel and oxidant flow field plates are substantially horizontal. In this way, the substantially horizontally oriented channels may readily drain water to fuel and oxidant ports 6, 7, 10, 11 on either side of the straight channels. Such a symmetrical arrangement is preferred to facilitate the draining of water in both directions in embodiments where fluid flow direction is periodically reversed. As shown in FIG. 1, fuel and oxidant ports 6, 7, 10, 11 are offset and have low points that are lower than the lowest point of the fluidly connected channels for purposes of drainage.

As disclosed in the aforementioned '356 application, elongated flow field plates like that depicted in FIG. 1a may provide for high current density operation in solid polymer electrolyte fuel cells supplied with gaseous reactants.

FIG. 1b shows a plan view of a representative elongated liquid reactant flow field plate that is suitable for use in a solid polymer electrolyte fuel cell operating on a liquid fuel (for example, a methanol/water mixture). Many of the features of preferred liquid fuel flow field plate 21 are similar to those of fuel flow field plate 1 in FIG. 1a. For instance, in FIG. 1b, liquid fuel channels 22 extend substantially between two opposing edges of elongated liquid reactant flow field plate 21. Liquid fuel is admitted at fuel inlet port 26, travels through passages 24, fuel channels 22, passages 25, and exhausts at fuel outlet port 27. Again, the fuel channel area corresponds to the area of the MEA. The passages are not considered part of the channels and the passages may curve in reflection of the configuration of the ports. Fuel channels 22 may have an open width of less than 0.75 millimeters and a length to cross sectional area ratio between about 2180:1 and 6200:1.

For use in a direct methanol fuel cell (DMFC) however, liquid reactant flow field plate 21 is desirably different in certain aspects from that of plate 1 in FIG. 1a. For instance, the aqueous methanol fuel mixture itself may desirably be used as a liquid coolant. If so, a separate coolant flow field and coolant fluid is not needed. Liquid reactant flow field plate 21 may then comprise an oxidant flow field on the opposite surface (not shown) obviating the need for a separate oxidant flow field plate in a fuel cell assembly. Plate 21 then serves as a bipolar plate and a fuel cell stack is made by stacking fuel cell assemblies in which each assembly comprises a liquid reactant flow field plate 21 and an MEA. Avoiding the use of separate flow field plates significantly reduces the size of the stack.

Further, a different configuration of ports for the reactants may be preferred for a liquid reactant flow field plate. Gaseous carbon dioxide is a product of the electrochemical reaction at the anode in a DMFC. Since the liquid fuel in a DMFC is often recirculated, carbon dioxide may be present at fuel inlet port 26 as well as at fuel outlet port 27. Pockets of carbon dioxide gas may disturb the flow of liquid fuel in channels 22 and/or passages 24, 25 if allowed to accumulate. Thus, fuel ports 26, 27 and passages 24, 25 are preferably arranged as shown such that the liquid fuel travels upwards to enter the channels, and also travel upwards to leave the channels, thereby facilitating the purge of carbon dioxide.

A gaseous oxidant (for example, air) is typically employed in a DMFC and it is still advantageous to have oxidant outlet port 29 located low on plate 21 for water drainage purposes. Airflow direction typically is not periodically reversed in a DMFC and so a symmetrical arrangement of the oxidant inlet and outlet ports may not be desired. (However, it may be desirable to employ a symmetrical arrangement of the ports for other reasons, such as for purposes of flexibility in arranging the stack.) Oxidant inlet port 28 may be located high on plate 21 as shown in FIG. 1a. Again, perimeter seal 23 circumscribes the fuel channel area and the various ports to effect appropriate fluid seals.

Liquid reactant flow field plate 21 is made from a suitably electrically conductive and substantially fluid impermeable material, such as expanded graphite. Graphite is chemically unreactive in a fuel cell environment and, compared to other materials with similarly suitable properties, graphite is relatively inexpensive. Expanded graphite is compressible and either embossing or molding processes may be used to form channels in one or both major surfaces of an expanded graphite sheet.

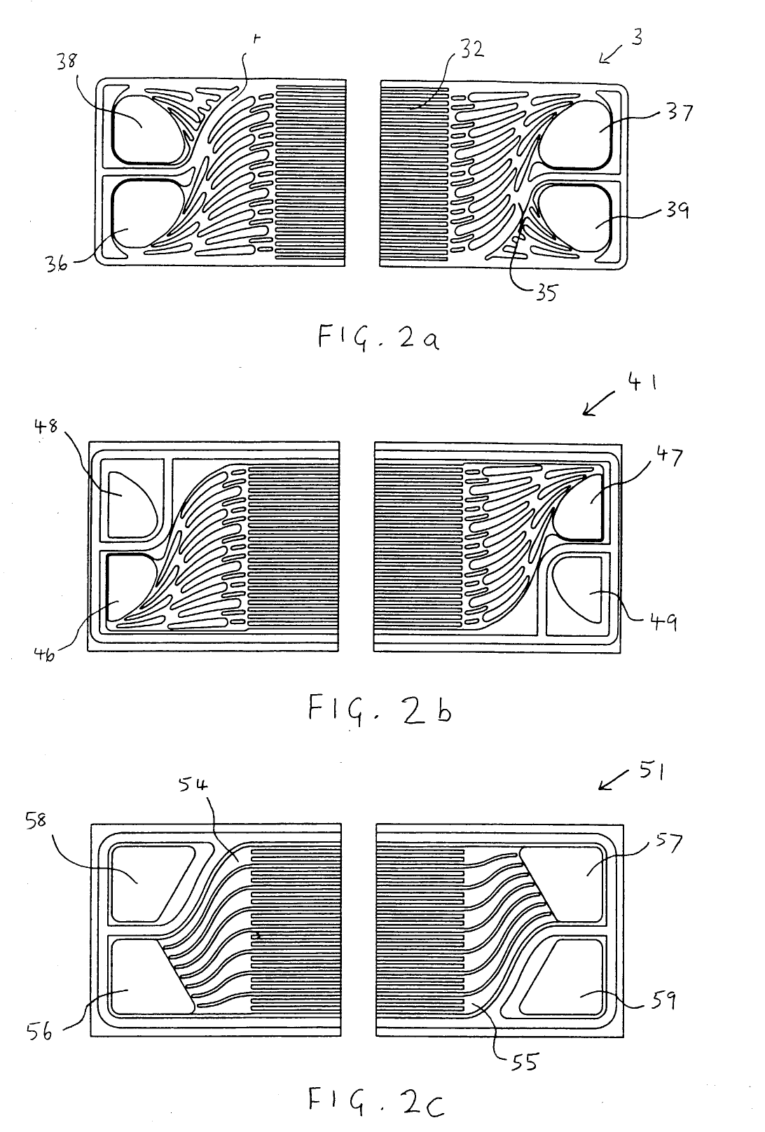

Consideration has been given to the size and shape of the inlet and outlet ports for appropriate liquid and gas flows. In this regard, FIGS. 2a, 2b, and 2c depict various port and passage configurations suitable for distributing reactants to the flow field channels and for preventing unwanted accumulation of reaction products (either carbon dioxide at the anode side or water at the cathode side). Liquid reactant flow field plate 31 in FIG. 2a comprises fuel inlet port 36, fuel outlet port 37, oxidant inlet port 38, and oxidant outlet port 39. Fuel passages 34 direct liquid fuel to channels 32 and then out to fuel passages 35. The perimeter seal in this embodiment is on the MEA itself and thus is not shown but it provides seals around the fuel channel area and the various ports. Liquid reactant flow field plate 41 in FIG. 2b differs from that in FIG. 2a in the size and shape of fuel inlet port 46, fuel outlet port 47, oxidant inlet port 48, and oxidant outlet port 49. Liquid reactant flow field plate 51 in FIG. 2c differs from that in FIG. 2a in the size and shape of ports 56, 57, 58, 59, and in the configuration of fuel passages 54, 55.

Generally, other aspects of the liquid reactant flow field plate construction may be similar to those for the flow field plates described in the '356 application. However, different seal materials may be required for compatibility with the liquid fuel mixture. Suitable seal materials for liquid fuels are known in the art. Consideration should also be given to ensure even distribution of reactant to all sections of the active electrode area and that the port sizing results in most of the pressure drop occurring in the flow field. Further, the flow field plate construction preferably is such that there are no traps for by-product gas in the liquid reactant flow field or for by-product liquid in a gaseous flow field.

Satisfactory performance at high current densities can be achieved in DMFCs using such liquid reactant flow field plates, as shown in the following example. This example is illustrative of certain aspects of the present fuel cell liquid reactant flow field plates, but should not be construed as limiting in any way. For instance, a DMFC embodiment is described which uses a liquid fuel flow field plate. However, the inventive liquid reactant flow field plates may be employed in fuel cells operating on other liquid reactants, either a different fuel or alternatively a liquid oxidant.

### EXAMPLE

A DMFC (cell A) was made using elongated liquid reactant flow field plates with substantially straight channels as illustrated in FIG. 1b. Its performance was then compared to that of a DMFC (cell B) made using conventional flow field plates with serpentine channels.

In both cells A and B, the same types of membrane electrode assemblies were used. The anodes comprised catalyst layers comprising unsupported platinum/ruthenium (at about 4 mg/cm² loading) and NAFION™ ionomer. The anode catalyst layers were applied on TGP grade (product from Toray) carbon fiber paper substrates. The cathodes comprised catalyst layers consisting of unsupported platinum (also at about 4 mg/cm² loading) and NAFION™ ionomer. The cathode catalyst layers were also applied onto TGP grade (product from Toray) carbon fiber paper substrates. However, in the case of the cathodes, the carbon fiber paper had first been coated with a carbon-based sublayer. The membrane electrolyte employed in each cell was NAFION™ 115 brand perfluorosulfonic acid polymeric membrane.

Cells A and B both used graphite flow field plates in which reactant passages and channels were milled into the surface. However, the plates in cell B were square (approximately 21 cm length sides) and the channel areas defined in the plate surfaces were also substantially square (approximately 17 cm by 16 cm length sides). On the other hand, the plates in cell A were rectangular as in FIG. 1b (approximately 71 cm by 5.3 cm) and the channel areas defined in the plate surfaces were also rectangular (approximately 61 cm by 4.7 cm). Further, the channels in cell B followed a serpentine path with multiple transits (that is, changes in direction) while those in cell A were straight. Further particulars on the flow field plate constructions in each cell are given in the Table below.

Table
Flow field plate characteristics

| | Oxidant | Oxidant | | |
|---|---|---|---|---|
| | plate | plate | Fuel plate | Fuel plate |
| | Cell B | Cell A | Cell B | Cell A |
| Channel | Serpentine | Straight | Serpentine | Straight |
| type | | | | |
| Landing | 0.020 inch | 0.014 inch | 0.049 inch | 0.046 inch |
| width | (0.50 mm) | (0.35 mm) | (1.24 mm) | (1.17 mm) |
| Channel | 0.043 inch | 0.039 inch | 0.035 inch | 0.029 inch* |
| width | (1.09 mm) | (0.99 mm) | (0.89 mm) | (0.74 mm) |
| Channel | 0.013 inch | 0.014 inch | 0.011 inch | 0.008 inch |
| depth | (0.33 mm) | (0.36 mm) | (0.28 mm) | (0.20 mm) |
| Channel | flat | arc | flat | flat |
| profile | bottom, | | bottom, | bottom, |
| | perpendic- | | perpendic- | tapered |
| | ular | | ular | sidewalls |
| | sidewalls | | sidewalls | |
| # | 5 | 1 | 5 | 1 |
| transits | | | | |
| # | 24 | 36 | 18 | 24 |
| channels | | | | |

*narrowest width

The relationship of output voltage to current density characteristics were then determined for each cell using a 0.4 M aqueous methanol solution as the fuel and air as the oxidant. In this testing, both fluids were supplied at 3 bar absolute pressure. The fluid flow rates were such that the fuel stoichiometry was 3 at all current densities and the oxidant stoichiometry was 2 at all current densities except at 50 mA/cm² where the latter was 2.5. (Stoichiometry is defined herein as the ratio of reactant supplied to the fuel cell to reactant consumed in the electrochemical reactions in the fuel cell.) Testing was done at about 110° C.

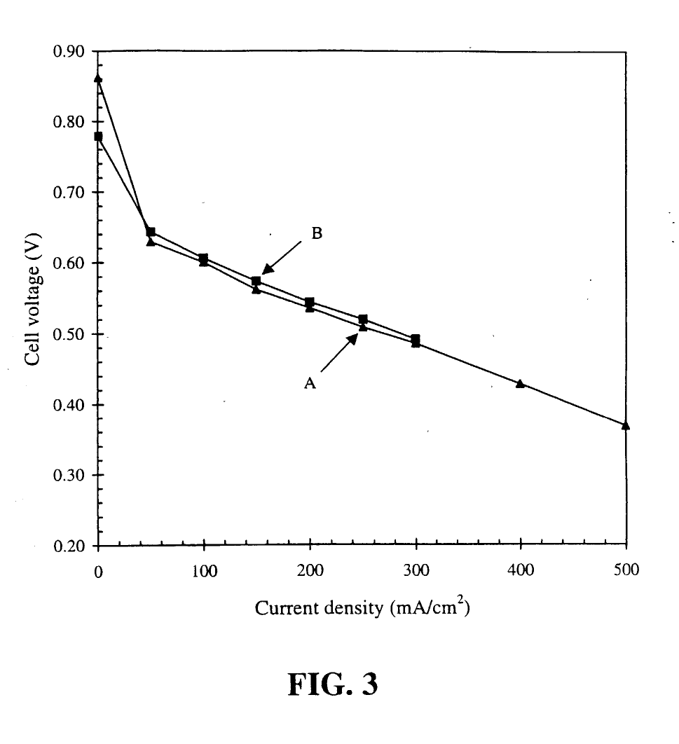

FIG. 3 shows the output voltage versus current density plots for cells A and B. As can be seen in FIG. 3, the output voltage of both cells was similar, thus illustrating that satisfactory performance may be achieved using an elongated liquid reactant flow field plate with straight channels. FIG. 3 shows that Cell A achieved satisfactory performance at a current density of 500 mA/cm².

As will be apparent to those skilled in the art in the light of the foregoing disclosure, many alterations and modifications are possible in the practice of this invention without departing from the scope thereof. Accordingly, the scope of the invention is to be construed in accordance with the substance defined by the following claims.

What is claimed is:

1. A liquid feed fuel cell comprising a liquid reactant flow field plate with opposing first and second major surfaces and at least one substantially straight liquid channel formed in said first major surface extending substantially between two opposing edges of said liquid reactant flow field plate wherein said liquid channel has an open width less than 0.75 millimeter.

2. The liquid feed fuel cell of claim 1 wherein said liquid channel has a length to cross-sectional area ratio of between about 2180:1 and about 6200:1.

3. The liquid feed fuel cell of claim 1 wherein said liquid feed fuel cell is a solid polymer fuel cell.

4. The liquid feed fuel cell of claim 3 wherein said liquid feed fuel cell is a direct methanol fuel cell.

5. The liquid feed fuel cell of claim 1 wherein said first major surface of said liquid reactant flow field plate comprises a plurality of substantially straight parallel liquid channels separated by lands, and wherein each of said plurality of liquid channels has an open width less than about 0.75 millimeter.

6. The liquid feed fuel cell of claim 5 wherein each of said plurality of liquid channels has a length to cross-sectional area ratio of between about 2180:1 and about 6200:1.

7. The liquid feed fuel cell of claim 1 further comprising at least one fluid channel formed in said second major surface.

8. The liquid feed fuel cell of claim 7 wherein said at least one fluid channel in said second major surface is oriented parallel to said plurality of liquid channels in said first major surface.

9. The liquid feed fuel cell of claim 1 wherein said liquid reactant flow field plate comprises expanded graphite.

10. A liquid feed fuel cell comprising a liquid reactant flow field plate with opposing first and second major surfaces and at least one substantially straight liquid channel formed in said first major surface of said flow field plate wherein said liquid channel has a length to cross-sectional area ratio of between about 2180:1 and about 6200:1.

11. A liquid feed fuel cell comprising at least one liquid fuel flow field plate with opposing first and second major surfaces and at least one substantially straight liquid fuel channel formed in said first major surface of said flow field plate wherein said flow field plate is oriented in said fuel cell such that during operation of said fuel cell, said major surfaces are substantially vertical and said liquid fuel channel is substantially horizontal.

12. The liquid feed fuel cell of claim 11 wherein said first major surface of said liquid fuel flow field plate comprises a plurality of substantially straight parallel liquid fuel channels separated by lands, and wherein said flow field plate is oriented such that said plurality of liquid fuel channels is substantially horizontal.

13. The liquid feed fuel cell of claim 12 wherein said liquid fuel flow field plate comprises a fuel inlet port at one end of said liquid fuel channels, said fuel inlet port being in a lower portion of said flow field plate, and a fuel outlet port at the other end of said liquid fuel channels, said fuel outlet port being in an upper portion of said flow field plate.

14. The liquid feed fuel cell of claim 13 wherein channels for oxidant are formed on said second major surface of said flow field plate.

15. The liquid feed fuel cell of claim 14 wherein said flow field plate comprises an oxidant inlet port at one end of said oxidant channels, said oxidant inlet port being in an upper portion of said flow field plate, and an oxidant outlet port at the other end of said oxidant channels, said oxidant outlet port being in a lower portion of said flow field plate.

16. The liquid feed fuel cell of claim 12 wherein said liquid fuel flow field plate comprises a fuel inlet port and a fuel outlet port symmetrically arranged at opposite ends of said liquid fuel channels.

17. The liquid feed fuel cell of claim 16 wherein channels for oxidant are formed on said second major surface of said flow field plate and said flow field plate comprises an oxidant inlet port and an oxidant outlet port symmetrically arranged at opposite ends of said oxidant channels.

18. The liquid feed fuel cell of claim 11 wherein said liquid feed fuel cell is a direct methanol fuel cell.

19. The liquid feed fuel cell of claim 12 wherein each of said plurality of liquid fuel channels has an open width less than about 0.75 millimeter.

20. The liquid feed fuel cell of claim 19 wherein each of said plurality of liquid fuel channels has a length to cross-sectional area ratio of between about 2180:1 and about 6200:1.
